(19) United States
(12) Patent Application Publication
(10) Pub. No.: US 2002/0149544 A1
(43) Pub. Date: Oct. 17, 2002

(54) Vehicular display system

(76) Inventors: John B. Rosen, Eugene, OR (US); Mark O. Snyker, Eugene, OR (US)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 10/077,384

(22) Filed: Feb. 15, 2002

Related U.S. Application Data
(63) Continuation-in-part of application No. 09/757,319, filed on Jun. 19, 2001.
(60) Provisional application No. 60/269,787, filed on Feb. 16, 2001.

(51) Int. Cl. G09G 5/00

(52) U.S. Cl. 345/6

(57) ABSTRACT

A display system is provided, such display system including a display with a generally horizontal display surface, and a reflecting element with an opaque reflective surface configured to reflect an image presented by the display for viewing by the vehicle occupant. The display system is configured to be mounted adjacent the front console, typically with the display embedded in the front console and the reflecting element mounted above the display at an angle relative thereto.

### RELATED APPLICATIONS

This application claims priority to U.S. Provisional Patent Application Serial No. 60/269,787, entitled Vehicular Display System, which names John B. Rosen and Mark Snyker as inventors. This application also is a continuation-in-part of U.S. patent application Ser. No. 09/757,319, entitled Vehicular Display System, which names John B. Rosen as inventor.

### TECHNICAL FIELD

The present invention relates generally to display devices, and more particularly, to a vehicular display device which presents an image for viewing by a vehicle occupant.

### BACKGROUND

Vehicular display devices have become increasingly popular in recent years, particularly where such display devices serve passengers entertainment, either recorded or live. For example, it is now common to find vehicles outfitted with displays linked to videocassette and digital video disk (DVD) players, computers, or other sources of information or entertainment content. These displays often fold down from a roof or ceiling of the vehicle, and typically are configured such that only rear-seat passengers can view the content displayed. Displays adapted for vehicle operators also have been employed, but for the purposes of presenting rear views, night vision capabilities, image of vehicle status information and the like. Display of entertainment content to vehicle operators is prohibited in many jurisdictions for safety reasons.

For non-operator video displays, location is typically not a problem. The displays may be conveniently located and brightly illuminated without regard for the need to operate the vehicle unhindered. Video displays intended for use by operators, however, typically must address concerns regarding location, brightness and visibility. These concerns must be addressed in the context of unhindered vehicle operation. Space restrictions also present particular difficulties in the usefulness of video displays intended for use by vehicle operators.

Although a number of systems have been developed for use in presenting information to vehicle operators, no known display has done so in a fashion which adequately addresses all of the concerns set forth herein. Direct video screens have been employed in large vehicles for rear viewing, but these displays typically require significant space, making them difficult to place in a location readily viewable by vehicle operators. Heads-up displays also have been suggested, such displays typically providing images reflected from the windshield to appear as if the images exist forwardly of the windshield. These systems, however, may be difficult to see due to difficulties with lighting, particularly in sunny environments. Further, the systems are typically complex to install, and may be distracting.

Accordingly, it would be desirable to provide a video display for use by front seat occupants which is characterized by the viewability more commonly found in rear seat passenger displays. It also would be desirable to provide a video display configured for placement within a vehicle in a position which will minimize interference with other vehicle operations. However, the display should maintain its effectiveness in providing meaningful information to a front seat occupant without detracting from the vehicle operator's view of the vehicle path, or of existing instrumentation.

### SUMMARY OF THE INVENTION

The foregoing objectives are achieved by provision of a display system which includes a display with a display surface, and a reflecting element with an opaque reflective surface configured to reflect an image presented by the display for viewing by the vehicle occupant. The display system may be configured to be mounted adjacent the front console of a vehicle, typically with the display embedded in the front console. Correspondingly, the reflecting element typically is mounted above the display and may be positionable at an angle relative to the display.

In one embodiment, the reflecting element is pivotal between a stowed orientation wherein the reflective surface is generally parallel with the display surface, and a deployed orientation wherein the reflective surface extends from the front console at an acute angle relative to the display surface. Therefore, where a vehicle driver has a central field of view and a peripheral field of view, the display may be deployed to a position within the driver's peripheral field of view, thus minimizing any interference with the driver's view of the vehicle path, or with existing instrumentation. An image source (such as a video camera, navigation system, vehicle processor, etc.) may be operatively connected to the display to provide the image for presentation on the display surface.

### BRIEF DESCRIPTION OF THE DRAWINGS

FIG. 1 is a cutaway side view of a vehicle which employs a vehicular display system in accordance with the present invention.

FIG. 2 is a detail cutaway side view showing a display unit of the display system of FIG. 1.

FIG. 3 is a cutaway top view of the vehicle of FIG. 1.

FIG. 4 is a cutaway side view of the front console of the vehicle of FIG. 1, with the display system of the present invention mounted thereon and shown in a deployed orientation.

FIG. 5 is a cutaway side view of the front console of the vehicle of FIG. 1, with the display system of the present invention mounted thereon and shown in a stowed orientation.

FIG. 6 is a cutaway side view showing a display system mounted atop the front console of a vehicle.

FIG. 7 is a schematic view of the vehicular display system shown in FIG. 1.

### DETAILED DESCRIPTION OF THE INVENTION AND BEST MODE OF SHOWING OUT THE INVENTION

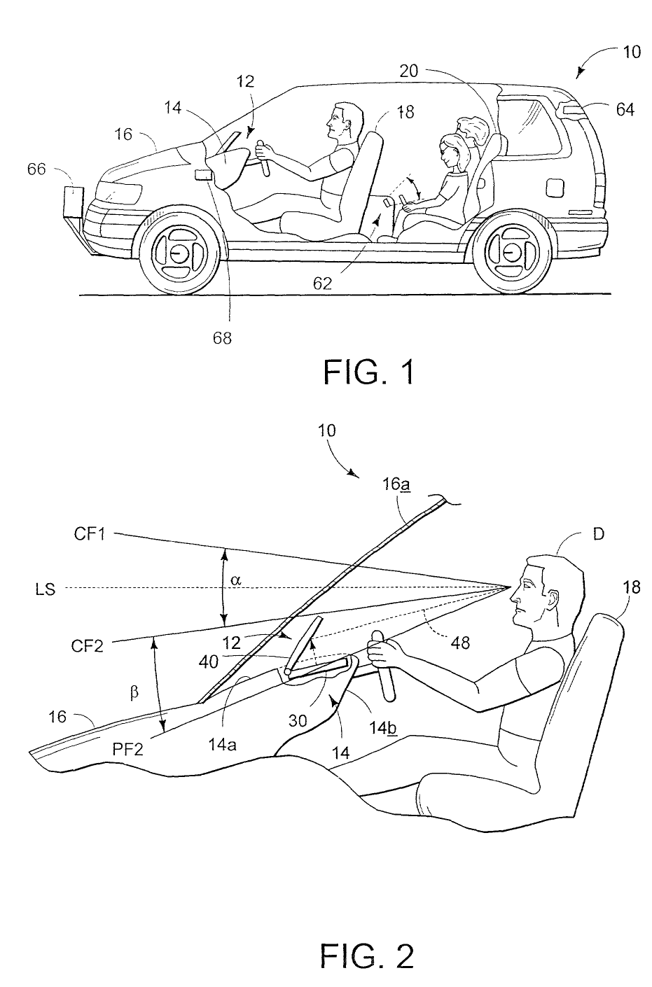

Referring initially to FIGS. 1 and 2, a vehicle 10 is shown, such vehicle being configured with a vehicular display system 12 constructed in accordance with the present invention. Display system 12 is mounted on the vehicle's front console 14, preferably for viewing by a driver in a peripheral region of the driver's field of view.

As indicated, the vehicle includes a chassis 16 with a windshield 16a through which a driver views the vehicle path (e.g. road), the chassis defining a vehicle interior. An interior area forward of front seats 18 serves as a front passenger area where the driver and front seat passenger are seated. The interior area between front seats 18 and rear seats 20 serves as a rear passenger area where rear seat passengers are seated, as shown. The vehicle also may be equipped with various video sources, including, for example, cameras 62, 64, 66, 68, an onboard vehicle processor 70, and/or a vehicle navigation system 80. It will be appreciated that other sources of data and/or video, such as a cell phone, a satellite receiver, etc. also may be used without departing from the scope of the invention. These sources provide images for presentation by the video display system under direction of a video control module 50 (FIG. 4).

Front console 14 takes the form of a vehicle dashboard such as that found below a vehicle windshield, such dashboard being configured to extend into the front passenger area to provide an upper dash surface 14a. A front dash surface 14b includes instrumentation viewable by the driver to enhance vehicle operation. The upper dash surface typically is generally horizontal, providing a suitable mounting structure for vehicular display system 12, as will now be described.

In accordance with the present invention, display system 12 includes a display 30 mounted adjacent the front console of the vehicle, typically in an orientation facing other than rearwardly in the vehicle. More typically, display 30 is a direct view display mounted on the dashboard in an upwardly-facing orientation. In a vehicle having a dashboard such as that shown here, the display may be embedded in the dashboard in a generally horizontal orientation so as to minimize interference with components already present in the dashboard.

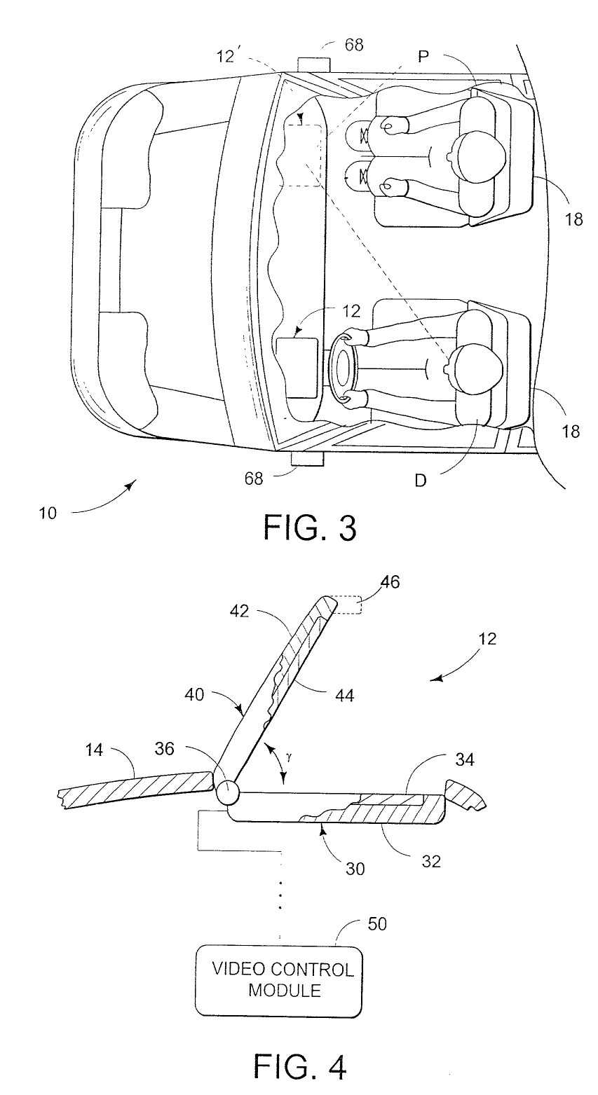

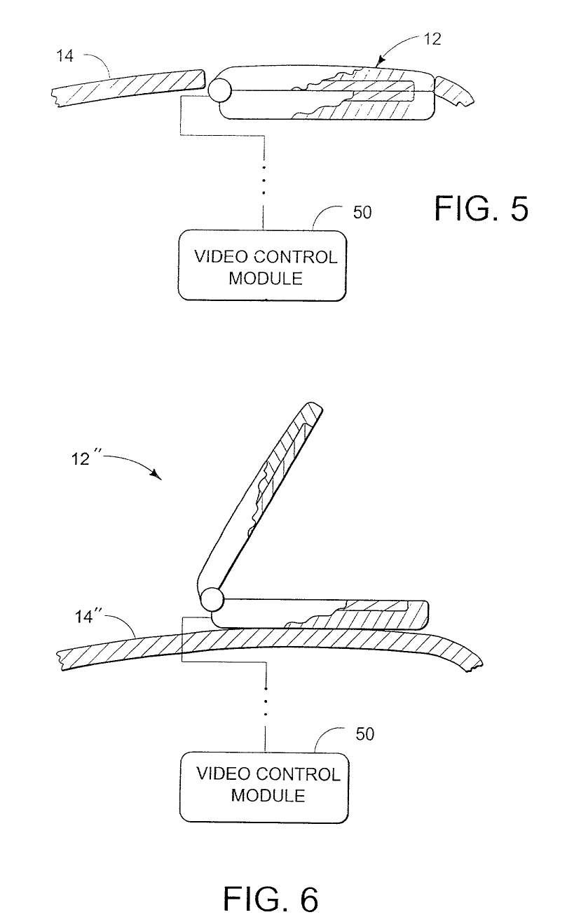

As shown, the depicted display includes a base 32, and a generally planar display surface 34, which presents a real image focused on the display surface such that it may be reflected for viewing by a vehicle occupant. Base 32 is configured for mounting to the vehicle dashboard, typically via conventional fasteners such as screws. In one embodiment, the base is embedded in the dashboard (FIGS. 1, 2, 4 and 5) in front of the driver of the vehicle. However, a display may similarly be mounted in front of the front seat passenger of the vehicle (FIG. 3). As indicated, such an embedded display may include a display housing contoured to mimic a contour of the dashboard, thereby accommodating seamless storage of the reflective element in the vehicle dashboard as best shown in FIG. 5.

Alternatively, the base may be mounted on the upper surface of the dashboard (FIG. 6). In any event, the display surface faces other than rearwardly, and more typically, faces in an upward direction. The display also may employ upright side walls (not shown) to shield the display surface from ambient light, and thus enhance viewability of the display.

Display 30 takes the form of a flat panel display (FPD), typically a liquid crystal display (LCD) or other flat panel technology display. The display may be of virtually any size, but preferably is intended for viewing by a front seat occupant, and thus employs a display screen which is on the order of approximately 4-inches to 8-inches, measured diagonally. The screen may be color or black-and-white, depending on the particular use to which the screen is to be put. To save space, various electrical components may be separated from the display screen, such components typically including video control circuitry (e.g. a central processing unit (CPU), multiplexors (MUX), on-screen display controls, and/or video/audio amplifiers), power supplies, etc.

Extending upwardly from display 30 is a reflecting element 40 configured to reflect the real image focused on the display for viewing by the vehicle occupant. As indicated, the reflecting element includes a housing 42, and a generally planar, opaque reflective surface 44. The reflecting element also may include a visor 46 and side walls (not shown) configured to reduce glare on reflective surface 44 and to shield the reflective surface from ambient light. These features also may serve to prevent light from display 30 from appearing on the vehicle windshield when it is dark outside the vehicle.

Reflecting element 40 typically takes the form of a mirror (glass, polished metal, or otherwise) positionable relative display 30 to reflect the image on the display surface for viewing of the image on the reflective surface. The reflecting element thus typically is positioned between the dashboard and the windshield at an acute angle relative to the display surface, and in close proximity thereto.

In the present embodiment, the reflecting element is secured to the display via a hinge 36, the reflecting element thus being pivotal between a stowed orientation (FIG. 5) wherein the reflective surface is generally parallel with the display surface, and a deployed orientation (FIG. 4) wherein the reflective surface extends upwardly from the dashboard at an acute angle γ relative to the display surface to reflect the image presented by the display for viewing by the vehicle occupant. The angle γ typically is chosen such that the reflecting path, shown in FIG. 2, reflects a focused image presented on display surface 34 off opaque reflecting surface 44 to the eye of driver D.

It will be appreciated that the reflecting element typically is further adjustable to accommodate viewing angles for occupants in differing operator positions. Furthermore, the display itself may be pivotally mounted to the dashboard (e.g. via a hinge) to accommodate further adjustment of the display system. Such a pivotal display may prove useful in maintaining an optimal relative angle between display surface 34 and reflective surface 44, even when the display is at a non-optimal angle relative to the dashboard.

Importantly, it will be noted from FIG. 2 that a vehicle occupant (such as driver D) has a central field of view along line-of-sight LS, where line-of-sight LS is selected to be a view of the vehicle path (approaching an imaginary line parallel to the vehicle path). The central field of view is denoted by an angle α, between lines CF1, CF2. Typically, the central field of view corresponds to the image formed in the fovea, parafovea, and perifovea regions of the driver's eye, and thus has an angular diameter of approximately 19 degrees. It will be appreciated that the central field of view is the field of view within which a driver views the vehicle path, and thus generally should be free of distractions.

In addition to the central field of view, the vehicle occupant has a peripheral field of view which extends about the periphery of the central field of view. Typically, the peripheral field of view has an angular diameter of approximately 29 degrees (corresponding to the near periphery region of the eye) surrounding the central field of view. FIG. 2 shows a lower portion of the peripheral field of view at β, between line CF2 and line PF2. As indicated, this peripheral field of view extends generally between the top edge of the dashboard and the central field of view, an area which typically does not contain any useful information in most vehicle applications.

Referring still to FIG. 2, it will be noted that reflective element 40 is selectively configured to extend upwardly from the dashboard in the peripheral field of view of the vehicle occupant to present a reflected image to the driver. Although the driver may glance down to view the reflected image (much like the driver glances down to view the instrument panel of the dashboard) the reflected image will not significantly detract from view of the vehicle path in the driver's central field of view.

As shown in FIG. 3, a driver-oriented vehicular display system 12 may be positioned in front of a driver D. A passenger-oriented vehicular display system 12′ similarly may be positioned in front of front seat passenger P. The orientation of the display and reflective element of the display of passenger-oriented vehicular display system make it difficult for the driver to view the presented image of the passenger-oriented vehicular display system. Use of a bi-directional film on the display may further restrict driver view of a passenger-side display. The driver's view of a passenger-side display is indicated generally by dashed line R in FIG. 3. The present display system thus is useful in displaying entertainment content to the front seat passenger while keeping such content out of view of the driver, as required by law in many areas.

Referring again to FIGS. 4 and 5, it will be appreciated that vehicular display system 12 has an associated video control module 50, which may be spaced from display 30 to conserve space in the vehicle dashboard. Video control module 50 may be configured to accommodate selection of an image source from a plurality of image sources, and may contain video control circuitry (e.g. a central processing unit (CPU), multiplexors (MUX), on-screen display controls, and/or video/audio amplifiers), power supplies, etc. Typically, the video image is processed for inverted presentation on display 30, so that the image appears in a right-side-up orientation to driver D after it is reflected by reflecting element 40.

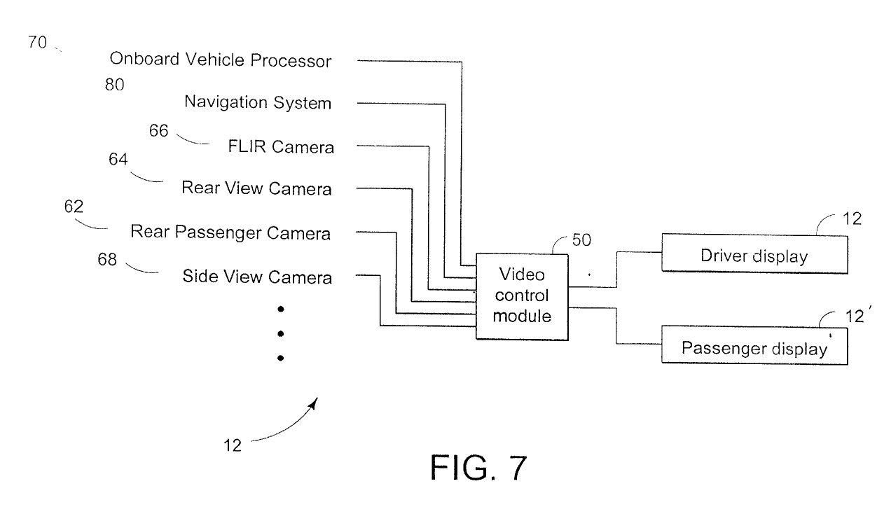

As indicated in FIGS. 1 and 7, the vehicular display system includes multiple image sources. For example, cameras may be provided at various locations on the vehicle to provide the driver with various views, both interior and exterior to the vehicle. In the depicted embodiment, camera 62 is mounted to a center floor console, and is trained on the rear seat passenger area to provide a view of rear seat occupants. It will be appreciated, however, that camera 62 may be mounted to a vehicle seat, the vehicle ceiling, or in virtually any other location within the vehicle.

The present embodiment also includes a rear view camera 64 mounted on the rear of the vehicle to provide an external rearward view from the vehicle, and a forward view camera 66 mounted on the front of the vehicle to provide an external forward view from the vehicle. The vehicle also may include side view cameras 68 which take the place of side view mirrors found on many vehicles. As a safety feature, these side view cameras may be linked to the vehicle's turn signal operations, presenting an appropriate view of the vehicle's “blind spot” when a turn signal is activated.

Forward view camera 66 may take the form of a forward-looking infrared (FLIR) camera mounted adjacent the front of the vehicle (or within the vehicle looking forward). FLIR camera 66 is configured to provide an infrared front view from the vehicle, and is especially useful in identifying hazards at night or at other times when visibility is poor. It will be appreciated that the FLIR camera image will change drastically when a live hazard (e.g. an animal) jumps into the road. This should be enough to attract the driver's attention, even where the reflective surface is in a peripheral field of view, causing the driver to look down, and react accordingly. Unlike known Head Up Display (HUD) systems, the proposed FLIR system may be used day or night.

An onboard vehicle processor 70, and a navigation system 80, also may serve as image sources for the vehicular display system. The onboard vehicle processor 70 may be configured to present an image containing vehicle status information such as vehicle speed, vehicle temperature, external temperature, fuel level, engine temperature, miles per hour, RPMs, fuel economy, etc. Navigation system 80 may be configured to generate an image containing navigation information such as maps, driving directions, weather information, traffic information, etc. Navigation system 80 may include a global positioning satellite (GPS) receiver, such that the system is able to present a map of the immediate surroundings of vehicle 10 in its current location.

Video control module 50 may be configured to select an image source for presentation on a display, or may be configured to present two or more image sources on a single display simultaneously in a split-screen or overlayed screen format. Similarly, a single video control module may be configured to present different images on different displays in accordance with each occupant's needs.

Turning now to FIG. 6, according to another embodiment of the invention, a display system 12″ may be mounted atop front console 14″. This embodiment typically is used in after-market installations of display systems. The display system, however, it will be noted, still may be connected to a video control module 50 as described above.

While the present invention has been particularly shown and described with reference to the foregoing preferred embodiments, those skilled in the art will understand that many variations may be made therein without departing from the spirit and scope of the invention as defined in the following paragraphs. The description of the invention should be understood to include all novel and non-obvious combinations of elements described herein, and paragraphs may be presented in this or a later application to any novel and non-obvious combination of these elements. The foregoing embodiments are illustrative, and no single feature or element is essential to all possible combinations that may be claimed in this or a later application. Where the paragraphs recite “a” or “a first” element or the equivalent thereof, such paragraphs should be understood to include incorporation of one or more such elements, neither requiring nor excluding two or more such elements.

Referring generally to the Attachment, there are depicted several illustrations of different versions of the vehicular display system, including versions mounted at various locations on a dashboard, as well as another version being mounted on an automobile steering column. The illustrations also include a view of one version of the invention without showing it being installed in a vehicle. The Attachment also includes several sheets of drawings with accompanying text showing various proposed mounting mechanisms for the vehicular display system. As seen in the drawings and described in the accompanying text, those mounting mechanisms allow for adjustments to accommodate different types of dashboard instruction, and also different needs of a user-driver (for example based upon the user-driver's height).

The invention may also be described by reference to the paragraphs below:

1. In a vehicle having a forward region, a display system comprising:

a display mounted in the forward region of the vehicle, the display including a generally horizontal display surface configured to present an image; and

a reflecting element including an opaque reflective surface configured to reflect the presented image for viewing by a vehicle occupant.

2. The display system of paragraph 1, wherein the vehicle includes a front console, the display being embedded in the front console.

3. The display system of paragraph 1, wherein the reflecting element is mounted above the display.

4. The display system of paragraph 1, wherein the reflective surface selectively extends from the display at a predetermined angle relative to the display surface to reflect the presented image for viewing by the vehicle occupant.

5. The display system of paragraph 4, wherein the reflecting element is pivotal between a stowed orientation wherein the reflective surface is generally parallel with the display surface, and a deployed orientation wherein the reflective surface extends from the display at a predetermined angle relative to the display surface to reflect the presented image for viewing by the vehicle occupant.

6. The display system of paragraph 4, wherein the display is pivotal relative to the front console.

7. The display system of paragraph 1, which further comprises an image source operatively connected to the display to provide the image for presentation on the display surface.

8. The display system of paragraph 7, wherein the image source is a video camera.

9. The display system of paragraph 8, wherein the video camera is configured to provide a rear view from the vehicle.

10. The display system of paragraph 8, wherein the video camera is configured to provide an interior view of the vehicle.

11. The display system of paragraph 10, wherein the video camera is trained on a rear seat passenger area of the vehicle.

12. The display system of paragraph 8, wherein the video camera is configured to provide a forward view from the vehicle.

13. The display system of paragraph 7, wherein the image source is a forward-looking infrared (FLIR) camera.

14. The display system of paragraph 7, wherein the image source is a navigation system.

15. The display system of paragraph 7, wherein the image source is a vehicle processor configured to provide an image including vehicle status information.

16. The display system of paragraph 1, wherein the display is a flat panel display.

17. The display system of paragraph 1, wherein the display is mounted in front of a driver of the vehicle.

18. The display system of paragraph 1, wherein the display is mounted in front of a front seat passenger of the vehicle.

19. In a vehicle having a front console, a display system comprising:

a direct view display mounted on the front console, the direct view display including an upwardly-facing display surface configured to present an image; and

a reflecting element including an opaque reflective surface configured to selectively extend upwardly from the front console at an angle relative to the display surface so as to reflect the presented image for viewing by a vehicle occupant.

20. The display system of paragraph 19, wherein the direct view display is embedded in the front console.

21. The display system of paragraph 19, wherein the reflecting element is mounted above the display.

22. The display system of paragraph 19, wherein the reflecting element is pivotal between a stowed orientation wherein the reflective surface is generally parallel with the display surface, and a deployed orientation wherein the reflective surface extends from the front console at an acute angle relative to the display surface to reflect the presented image for viewing by the vehicle occupant.

23. The display system of paragraph 19, wherein the display is pivotal relative to the front console.

24. The display system of paragraph 19, which further comprises an image source operatively connected to the display to provide the image for presentation on the display surface.

25. The display system of paragraph 24, wherein the image source is a video camera.

26. The display system of paragraph 24, wherein the image source is a forward-looking infrared (FLIR) camera.

27. The display system of paragraph 24, wherein the image source is a navigation system.

28. The display system of paragraph 24, wherein the image source is a vehicle processor configured to provide an image including vehicle status information.

29. The display system of paragraph 19, wherein the direct view display is a flat panel display.

30. The display system of paragraph 19, wherein the display is mounted in front of a driver of the vehicle.

31. The display system of paragraph 19, wherein the display is mounted in front of a front seat passenger of the vehicle.

32. A vehicle comprising:

a driver seat configured to be occupied by a driver, the driver having a central field of view and a peripheral field of view when viewing a vehicle path;

a dashboard forward of the driver seat; and

a display system including a dashboard-mounted, upwardly-facing display surface configured to present a real image and an opaque reflective surface which selectively extends upwardly from the dashboard at an angle relative to the display surface in the peripheral field of view of the driver when the driver is viewing the vehicle path, the reflective surface being configured to reflect the real image for presentation to the driver.

33. The vehicle of paragraph 32, wherein the reflective surface is outside of the driver's central field of view when the driver is viewing the vehicle path.

34. The vehicle of paragraph 32, wherein the reflective surface is pivotal between a stowed orientation wherein the reflective surface is generally parallel with the display surface, and a deployed orientation wherein the reflective surface extends from the dashboard at an acute angle relative to the display surface to reflect the presented image for viewing by the driver.

35. The display system of paragraph 32, wherein the display is pivotal relative to the dashboard.

36. The vehicle of paragraph 32, which further comprises an image source operatively connected to the display surface to provide the image for presentation on the display surface.

37. The vehicle of paragraph 36, wherein the image source is a camera.

38. The vehicle of paragraph 36, wherein the image source is an onboard processor configured to produce an image.

39. In a vehicle having a dashboard, a display system comprising:

a direct view display mounted on the dashboard, the display including a generally upwardly-facing display surface configured to present a real image;

a reflecting element including an opaque reflective surface which extends upwardly from the dashboard at an angle relative to the display surface to reflect the presented image for viewing by a vehicle occupant, the reflecting element thus having a proximal end adjacent the display surface and a distal end spaced from the display surface; and

a visor projecting from the distal end of the reflecting element to shade the reflecting element from ambient light.

40. The display system of paragraph 39, wherein the vehicle occupant is a driver having a central field of view and a peripheral field of view when viewing a vehicle path, and wherein the reflective surface is positioned in the peripheral field of view of the driver when the driver is viewing the vehicle path.

41. The display system of paragraph 39, which further comprises an image source operatively connected to the display surface to provide the image for presentation on the display surface.

42. The display system of paragraph 41, wherein the image source is a camera.

43. The display system of paragraph 41, wherein the image source is an onboard processor configured to produce an image.

44. In a vehicle having a dashboard, a display system comprising:

an image source;

a flat panel display embedded in the dashboard, the flat panel display including a control module operatively connected to the image source to condition an image for presentation on the display, and an upwardly-facing display surface spaced from the control module and configured to present the image; and

a reflecting element including an opaque reflective surface which selectively extends upwardly from the dashboard at an angle relative to the display surface to face a vehicle occupant, the reflective surface being configured to reflect the presented image for viewing by the vehicle occupant.

45. The display system of paragraph 44, wherein the reflective surface is pivotal between a stowed orientation wherein the reflective surface is generally parallel with the display surface, and a deployed orientation wherein the reflective surface extends from the dashboard at an acute angle relative to the display surface to reflect the presented image for viewing by the driver.

46. The display system of paragraph 44, which further comprises an image source operatively connected to the display surface to provide the image for presentation on the display surface.

47. The display system of paragraph 46, wherein the image source is a camera.

48. The display system of paragraph 46, wherein the image source is an onboard processor configured to produce an image.

49. A display system comprising:

a base including a flat panel display with an upwardly-facing display surface; and

a mirror including an opaque reflective surface, the mirror being pivotally mounted to the base for pivot between a stowed orientation wherein the reflective surface is generally parallel with the display surface, and a deployed orientation wherein the reflective surface extends upwardly from the display surface at an angle relative to the display surface to reflect the presented image for viewing of the presented image on the reflective surface.

50. In a vehicle having a front console, a display system comprising:

a display mounted at the front console, the display including a display surface facing other than rearwardly of the vehicle and configured to present a focused image thereon;

a reflecting element mounted at the front console and including an opaque reflective surface configurable to reflect the focused image for viewing within the vehicle.

51. The display system of paragraph 50, the display surface being a flat panel display substantially parallel to the immediate surrounding upper surface of the front console.

52. The display system of paragraph 51, the reflecting element being configured for orientation at an acute angle relative the display.

53. The display system of paragraph 52, the reflecting element having a first position with the reflecting element oriented for reflecting the focused image for viewing by a vehicle occupant, and a second position with the reflecting element oriented substantially parallel to and covering the display.

54. The display system of paragraph 50, the vehicle further having an operator position, the reflecting element being pivotally mounted relative to the display to provide a range of pivotal locations of the reflecting element relative to the display to accommodate the angle of viewing from the operator position.

55. The display system of paragraph 54, the reflecting element having a first position wherein the reflecting element is oriented at an acute angle relative to the display.

56. The display system of paragraph 55, the reflecting element further having a second position with the reflecting element oriented substantially parallel and covering the display.

57. The display system of paragraph 50 further comprising:

a visor affixed to the reflecting element.

58. The display system of paragraph 50 further comprising:

an image source operatively connected to the display and including at least one source of image signals.

59. The display system of paragraph 58, the source of image signals including at least one video camera operatively connected to the display.

60. The display system of paragraph 59, the at least one video camera being orientated to provide a rear view from the vehicle.

61. The display system of paragraph 59, the at least one video camera being orientated to provide an interior view of the vehicle.

62. The display system of paragraph 59, the vehicle further having a rear seat, the at least one video camera being orientated to provide a view of the rear seat in the vehicle.

63. The display system of paragraph 59, the at least one video camera being oriented to provide a front view from the vehicle.

64. The display system of paragraph 59, the image source further including a video control module operatively connected with and between the display and the at least one video camera.

65. The display system of paragraph 64, the vehicle further having electric turn signals, the at least one video camera including a first video camera oriented to provide a view from the left side of the vehicle and a second video camera oriented to provide a view from the right side of the vehicle, the video control module being configured to present the image from the first video camera on the display when the left turn signal is activated and to present the image from the second video camera on the display when the right turn signal is activated.

66. The display system of paragraph 58, the at least one source image signals including a forward-looking infrared camera.

67. The display system of paragraph 58, the at least one source image signals including a navigation system.

68. The display system of paragraph 58, the at least one source of image signals including a vehicle processor configured to generate an image depicting vehicle status information.

69. The display system of paragraph 50, the display being embedded in an upper surface of the front console.

70. In a vehicle having a front console and an operator position behind the front console, a display system comprising:

a display pivotally mounted relative to the front console, the display including a display surface facing other than rearwardly of the vehicle and configured to present a focused image thereon;

a reflecting element mounted at the front console and including an opaque reflecting surface configurable in a range of pivotal locations relative to the display to reflect the focused image and to accommodate an angle of viewing from the operator position; and

an image source operatively connected with the display, the image source including at least one video camera operatively connected with the display and a video control module operatively connected with and between the display and the at least one video camera.

71. The display system of paragraph 70, the at least one video camera being oriented to provide a rear view from the vehicle.

72. The display system of paragraph 70, the at least one video camera being orientated to provide an interior view of the vehicle.

73. The display system of paragraph 70, the vehicle further having a rear seat, the at least one video camera being oriented to provide a view of the rear seat in the vehicle.

74. The display system of paragraph 70, the at least one video camera being orientated to provide a front view from the vehicle.

75. The display system of paragraph 70, the vehicle further having electric turn signals, the at least one video camera including a first video camera oriented to provide a view from the left side of the vehicle and a second video camera orientated to provide a view from the right side of the vehicle, the video control module being configured to present the image from the first video camera on the display when the left turn signal is activated and to present the image from the second video camera on the display when the right turn signal is activated.

76. The display system of paragraph 70, the image source including a forward-looking infrared camera.

77. The display system of paragraph 70, the image source including a navigation system.

78. The display system of paragraph 70, the image source including a vehicle processor configured to generate an image depicting vehicle status information.

79. In a vehicle having a front windshield, a front console extending toward the front window and an operator position behind and facing toward the front console, a display system comprising:

a display mounted at the front console, the display including a display surface facing other than rearwardly of the vehicle and configured to present a focused image thereon; and

a reflecting element pivotally mounted relative to the display at the front console and including an opaque reflective surface configured to reflect the focused image, the reflecting element having a first position providing a range of pivotal locations relative to the display to accommodate vertically the angle of viewing from the operator position, the reflecting element being pivotally mounted between the display and the front windshield.

80. The display system of paragraph 79 further comprising:

a visor at the reflecting element positioned to shade the opaque reflective surface and the display surface from light through the front windshield.

81. The display system of paragraph 79, the display surface being a flat panel display substantially parallel to the immediately surrounding upper surface of the front console.

82. The display system of paragraph 81, the reflecting element in the first position being orientated at an acute angle relative to the display.

83. The display system of paragraph 82, the reflecting element further having a second position with the reflecting element orientated substantially parallel to and covering the display.

84. The display system of paragraph 79, the reflecting element being pivotally mounted relative to the display and the first position providing a range of pivotal locations relative to the display to accommodate the angle of viewing from the operator position.

85. The display system of paragraph 84, the reflecting element in the first position being oriented at an acute angle relative to the display.

86. The display system of paragraph 85, the reflecting element further having a second position with the reflecting element orientated substantially parallel to and covering the display.

87. The display system of paragraph 79 further comprising:

an image source operatively connected with the display.

88. The display system of paragraph 79, the display being embedded in the upper surface of the front console.

89. A vehicle comprising:

a front console;

an operator position behind the front console in the vehicle; and

a display system including a display mounted at the front console, the display including a display surface facing other than rearwardly of the vehicle and configured to present a focused image thereon and a reflecting element mounted at the front console and including an opaque reflective surface configurable to reflect the focused image for viewing from the operator position.

90. The vehicle of paragraph 89, the display surface being a flat panel display substantially parallel to the immediately surrounding upper surface of the front console.

91. The vehicle of paragraph 90, the reflecting element being configurable in a first position with the reflecting element oriented at an acute angle relative to the display.

92. The vehicle of paragraph 91, the reflecting element further being configurable in a second position with the reflecting element oriented substantially parallel to and covering the display.

93. The vehicle of paragraph 89, the reflecting element being pivotally mounted relative to the display to provide a range of pivotal locations relative to the display to accommodate the angle of viewing from the operator position.

94. The vehicle of paragraph 93, the reflecting element being configurable in a first position with the reflecting element oriented at an acute angle relative to the display.

95. The vehicle of paragraph 94, the reflecting element further being configurable in a second position with the reflecting element oriented substantially parallel to and covering the display.

96. The vehicle of paragraph 89, the display being embedded in the upper surface of the front console.

97. A vehicle comprising:

a front console;

an operator position behind the front console of the vehicle; and

a display system including a display pivotally mounted relative to the display at the front console, the display including a display surface facing other than rearwardly of the vehicle and configured to present a focused image thereon, a reflecting element mounted at the front console and including an opaque reflective surface configured to reflect the focused image, the reflecting element being configurable in a range of locations to reflect the focused image for viewing by a vehicle occupant and to accommodate the position of the operator, and an image source operatively connected with the display, the image source including at least one source of image signals operatively connected with the display and a video control module operatively connected with and between the display and the at least one source of image signals.

98. The vehicle of paragraph 97, the at least one source of image signals including at least one video camera operatively connected with the display.

99. The vehicle of paragraph 98, the at least one video camera being oriented to provide a rear view from the vehicle.

100. The vehicle of paragraph 98, the at least one video camera being oriented to provide an interior view of the vehicle.

101. The vehicle of paragraph 98 further comprising:

a rear seat, the at least one video camera being oriented to provide a view of the rear seat in the vehicle.

102. The vehicle of paragraph 98, the at least one video camera being oriented to provide a front view from the vehicle.

103. The vehicle of paragraph 98 further comprising:

electric turn signals, the at least one video camera including a first video camera oriented to provide a view from the left side of the vehicle and a second video camera oriented to provide a view from the right side of the vehicle, the video control module being configured to present the image from the first video camera on the display when the left turn signal is activated and to present the image from the second video camera on the display when the right turn signal is activated.

104. The vehicle of paragraph 98, the at least one source of image signals including a forward-looking infrared camera.

105. The vehicle of paragraph 98, the at least one source of image signals including a navigation system.

106. The vehicle of paragraph 98, the at least one source of image signals including a vehicle data processor configured to generate an image depicting vehicle status information.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. In a vehicle having a forward console, a display system comprising:
a display mounted on the forward console of the vehicle, the display including a generally horizontal display surface configured to present an image; and
a reflecting element including an opaque reflective surface configured to reflect the presented image for viewing by a vehicle occupant.

2. The display system of claim 1, wherein the forward console includes a steering mechanism, and wherein the display is mounted forward of the steering mechanism.

3. The display system of claim 1, wherein the forward console includes a steering column with a steering wheel, and wherein the display is mounted on the steering column forward of the steering wheel.

4. The display system of claim 3, wherein the display is mounted along a central axis of the steering column.

5. A display system comprising:
a base including a display with an upwardly-facing display surface; and
a mirror including an opaque reflective surface, the mirror being pivotally mounted to the base for pivot between a stowed orientation wherein the reflective surface is generally parallel with the display surface, and a deployed orientation wherein the reflective surface extends upwardly from the display surface at an angle relative to the display surface to reflect the presented image for viewing of the presented image on the reflective surface.

6. The display system of claim 5, wherein the mirror is a concave mirror.

7. The display system of claim 5, wherein the mirror is a convex mirror.

8. The display system of claim 5, wherein the mirror is a flat-plane mirror.

9. The display system of claim 5, wherein the mirror is a flat-to-concave mirror.

10. The display system of claim 5, wherein the mirror is a flat-to-convex mirror.

11. A vehicle comprising:
a front console including a vehicle steering mechanism supported on a steering column which defines a first axis;
an operator position behind the steering mechanism in the vehicle along the first axis; and
a display system including a display mounted at the steering column along the first axis, the display including a display surface facing other than rearwardly of the vehicle and configured to present a focused image thereon and a reflecting element mounted at the front console and including an opaque reflective surface configurable to reflect the focused image for viewing from the operator position.
